(19) United States
(12) Patent Application Publication
(10) Pub. No.: US 2003/0212681 A1
(43) Pub. Date: Nov. 13, 2003

(54) Database access blocking during synchronization

(75) Inventor: David J. Kasper II, Aliso Viejo, CA (US)

Correspondence Address: Fogg Slifer Polglaze Leffert & Jay, P.A., P.O. Box 581009, Minneapolis, MN, 55458-1009, US

(73) Assignee: ADC DSL Systems, Inc.

(21) Appl. No.: 10/142,012

(22) Filed: May 8, 2002

(51) Int. Cl. G06F 17/30

(52) U.S. Cl. 707/9

(57) ABSTRACT

Multiple local databases are coupled to a master database. The master database includes a number of data objects to be synchronized with the local databases. The state of the objects stored in the local databases is initially set to a pending state. A request is made to synchronize the local database with the master database. The state of the last object to be synchronized is periodically read. Read access to the local database is blocked until the last object indicates that it has been synchronized.

### TECHNICAL FIELD

The present invention relates generally updating local databases from master databases.

### BACKGROUND

Systems that employ databases can have one master copy of the information contained in the database and multiple “local” copies. The local copies may be exact copies of the master database information or the local copies may be a subset of the information that is stored in the master database.

In order for the local databases to have the most up-to-date information from the master database, the local databases must be periodically synchronized with the master database. For example, if the master database is updated with new information, the local databases typically will not have this new information until the databases are synchronized.

One problem with synchronizing databases in a system is that other system processes may take priority over the synchronization of the information. The time required to complete the synchronization process may be better spent on a higher priority process. Additionally, a user may access a local database prior to the local database being synchronized with the master database, possibly receiving old information. There is a resulting need in the art for being able to synchronize, in the background, local databases with a master database.

### SUMMARY OF THE INVENTION

The embodiments of the present invention encompass local database access blocking during synchronization with a master database. In one embodiment, the local database is capable of storing objects to be synchronized.

A method of the present invention sets a status indication for each object to be synchronized. The status indication initially indicates that each object to be synchronized is not synchronized.

A synchronization of the objects is requested from the master database. In one embodiment, read access to the local database is blocked until the status indication for the last synchronized object shows that it has been synchronized.

### BRIEF DESCRIPTION OF THE DRAWINGS

FIG. 1 shows a block diagram of one embodiment of a distributed database system of the present invention.

FIG. 2 shows a flowchart of one embodiment of a database synchronization method of the present invention.

FIG. 3 shows a block diagram of one embodiment of a communication system in accordance with the synchronization method of the present invention.

FIG. 4 shows a block diagram of one embodiment of a management card in accordance with the synchronization method of the present invention.

FIG. 5 shows a block diagram of one embodiment of a line card in accordance with the synchronization method of the present invention.

### DETAILED DESCRIPTION

The embodiments of database synchronization of the present invention provide background synchronization of multiple local databases with a master database. The synchronization can be accomplished without impacting the time required to complete other processes while also preventing database access until a successful synchronization has been achieved.

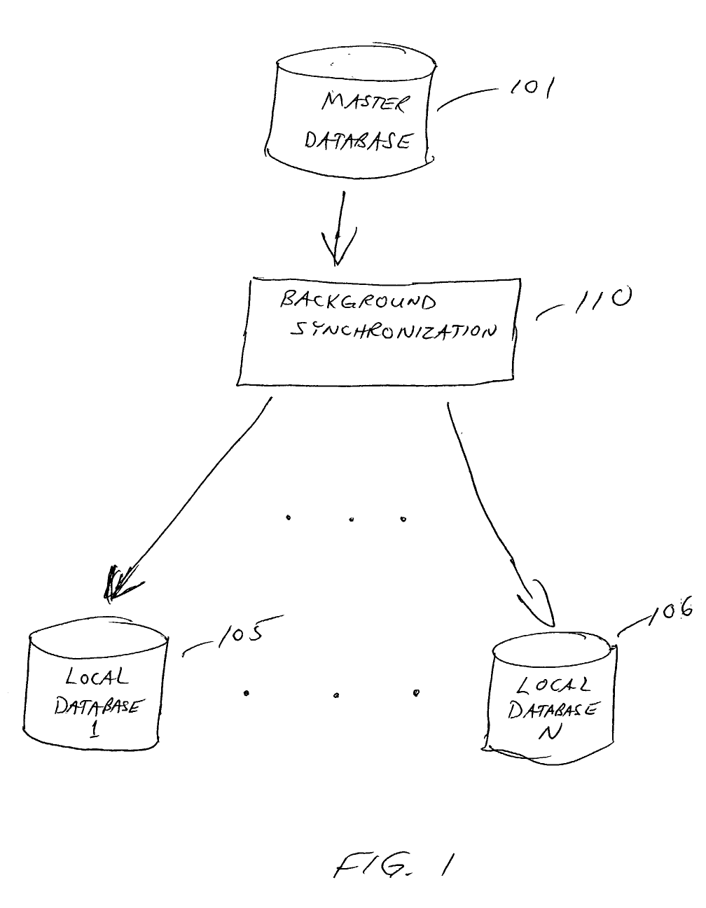

FIG. 1 illustrates a block diagram of one embodiment of a distributed database system of the present invention. The master database (101) stores information/data for later retrieval. In one embodiment, the master database (101) stores statistics regarding a quality of service provided over a communication line (e.g., a digital subscriber line (DSL)).

In one embodiment, each statistic in the database is referred to as an object or element. For example, in one embodiment, if the data stored in the database includes statistics on the quality of service of a communication link, one object stored in the database is a bit error rate for each link that is coupled to the master database. Other types of objects/elements include link downtime, link bit rate, and subscriber information.

In alternate embodiments, the database is used for storing information that is not related to communication link quality of service. In such embodiments, the objects/elements are not communication link related. The types of objects/elements stored in the database do not limit the present invention.

The master database (101) is coupled to multiple local databases (105-106). The embodiment of FIG. 1 illustrates these databases as local database 1 (105) through local database N (106). These local databases (105-106) can be of any size.

The local databases (105-106), in one embodiment, have the capacity to hold a substantially equivalent copy of the data that is stored in the master database (101). In another embodiment, the memory capacity of the local databases (105-106) is such that only a subset of the data stored in the master database (101) will fit in the local databases.

The databases (101, 105, and 106) of the present invention are stored in some form of memory. In one embodiment, the database memory is of the type used for temporary storage of data such as random access memory (RAM). The database memory may also be of the type used for permanent storage of data such as read only memory (ROM), programmable read only memory (PROM), and/or memory cards.

Other types of database memory may include semiconductor, magnetic, optical, or storage media. The storage media memory can include hard disk drives, floppy disk drives, optical drives, removable solid-state memory cards, or any other type of storage media. The storage media may be fixed or removable from a database system.

The master database (101) and the local databases (105-106) are coupled through a background synchronization block (110). As described subsequently, the background synchronization block (110) provides a method by which the local databases (105-106) are updated with data from the master database (101).

In one embodiment of the present invention, the objects stored on the local databases each have a flag that indicates a synchronized or not synchronized status of the object. In one embodiment, the flag indicates either “pending” or “ready”.

The “pending” flag indicates that the object has not been synchronized with the master database and, therefore, may not be accurate and up-to-date. The “ready” flag indicates that the object has already been successfully synchronized with the master database.

In one embodiment, the “pending” and “ready” flag takes the form of a single bit of data. For example, if the flag is a logic 0, the flag is set for “pending”. If the flag is a logic 1,the flag is set for “ready”. Other embodiments may use other flags to indicate the “pending” and “ready” states.

The “pending” and “ready” states are for illustration purposes only. Alternate embodiments may use other states that perform substantially the same function as the states of the present invention. For example, in one embodiment, a “pending” flag is set by a bit set to a logical 1. If that bit is not present, then the object has been synchronized and is considered “ready” for processing.

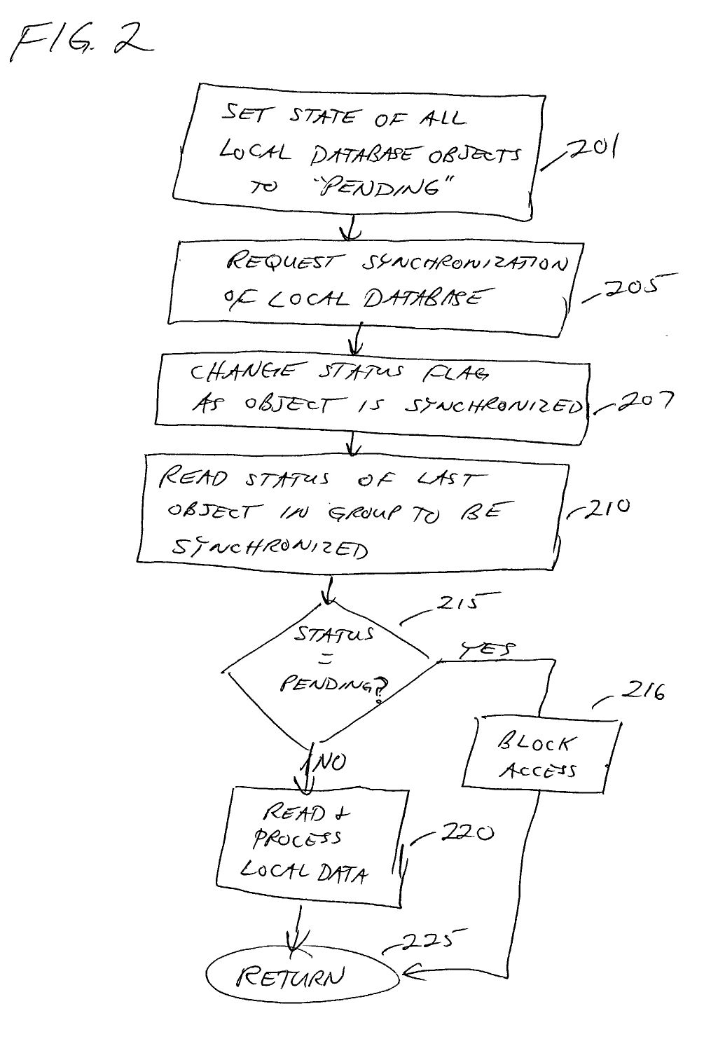

FIG. 2 illustrates a flowchart of one embodiment of a background synchronization method of the present invention. In one embodiment, the local databases start off empty and the synchronization method loads the requested objects into the requesting local database memory. In another embodiment, the local databases already have objects in memory that are overwritten by objects requested from the master database.

While the subsequently described method refers to one local database, the same method may apply to each of the 1-N local databases. One local database is used for illustration purposes only.

The status flags of any of the local database objects are set to “pending” (201). A request is made for synchronization of the local database with the master database (205).

In one embodiment, in the request for synchronization (205), the request is to synchronize the entire local database or only a desired group of objects. For example, the group of objects to be synchronized may include only the bit error rate and the down time and not the other objects stored in either the master or local databases.

In one embodiment, the objects to be synchronized are downloaded from the master database to the local database. These downloaded objects then replace the older objects in the local database.

In another embodiment, the objects to be synchronized are operated on by a process that determines whether the local database objects are more recent or whether the master database objects are more recent. If the local objects are the most recent, these objects overwrite the objects in the master database. If the master database objects are more recent, the objects from the master database overwrite the older objects in the local database. If the objects to be synchronized are not already present in the other database, they are written to that database.

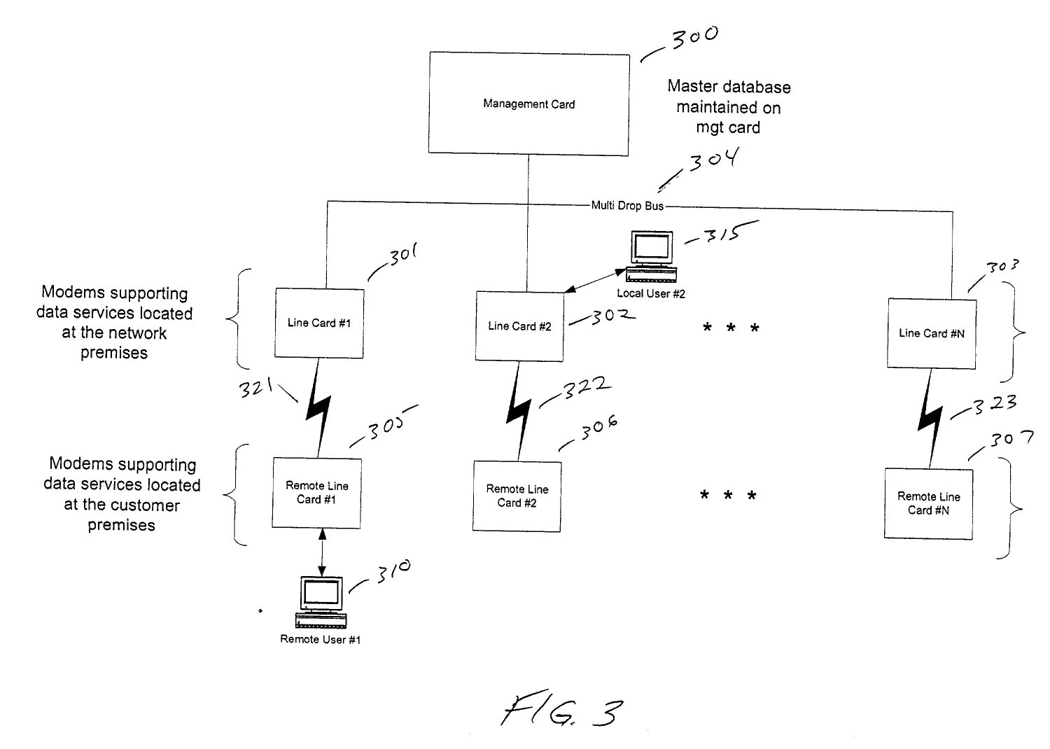

The local database, in one embodiment, requests synchronization using a request command from a card controller that is transmitted over a data bus. Such a configuration is discussed subsequently with reference to FIG. 3.

As the objects are transferred to the local database, their associated status flags are changed (207) to “ready” or some equivalent indication. The status flag of the last object in the group of objects to be synchronized is checked (210). If the status flag is “pending” (215), read access to the local database is blocked (216) so that objects that have not been synchronized cannot be read and processed.

In one embodiment, this blocking is accomplished by a memory read subroutine not permitting access until the last object has a “ready” flag. Other techniques, that are well known in the art, may be used to block access to the memory until the database is synchronized. The present invention is not limited to any one technique. The method then returns (225) to the database access method that initiated the request for synchronization.

In an alternate embodiment, each of the status flags of each synchronized object is checked. If any of the objects to be synchronized still has a “pending” flag set, access to the local database is blocked and the method returns to the initiating method.

With the synchronization method of the present invention, a controller running various processes is not tied up waiting for the synchronization method to be completed. Only periodic checking is required to determine the status of the synchronization.

If the status flag of the last object, or all the objects, in the group is checked and found to be set to “ready” (215), the objects in the local database are read and processed as required (220).

FIG. 3 illustrates a block diagram of a typical communication system in accordance with the background synchronization method of the present invention. The system of FIG. 3 is for illustration purposes only and does not limit the synchronization method to this particular type of system.

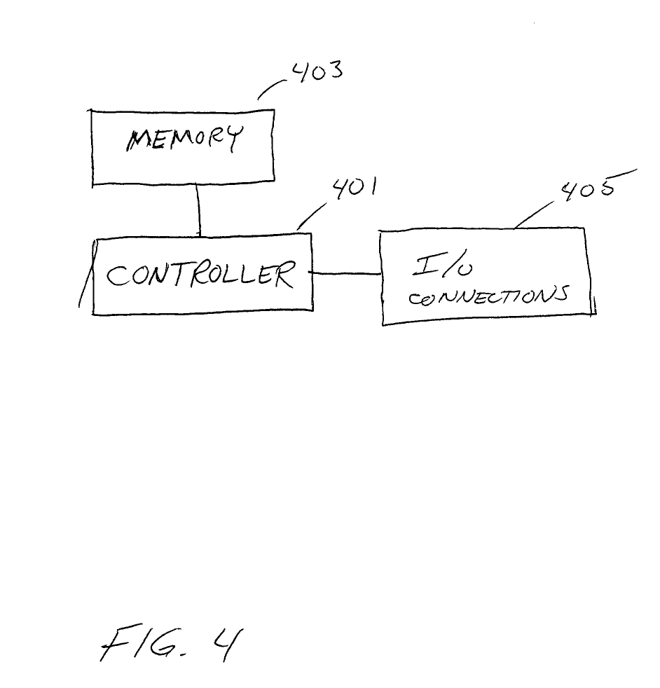

This system includes a management card that is responsible for controlling the system of the present invention. In one embodiment, the master database is maintained on the management card or other type of controller card. One embodiment of the management card is described subsequently with reference to FIG. 4.

Line cards 1-N (301-303) are coupled to the management card (300) through a multi-drop bus or backplane (304). In the communication system embodiment, line cards 1-N (301-303) are modems that support data services that are provided to customers. The local databases of the present invention are maintained on the line cards.

Each line card (301-303) is coupled to a communication link (321-323 respectively). The communication link may be a T1 line, a DSL line, a wireless link, or any other form of communication link depending on the type of data services provided by each line card. The communication system of the present invention is not limited to any one form of communication link.

The communication links (321-323) couple their respective line card to a remote line card (305-307) that is located at the customer's site. Remote line cards 1-N (305-307) are the same type of modem as the respective line card to which it is coupled. In other words, if line card 1 (301) is a DSL modem, remote terminal 1 (305) is a DSL modem.

In one embodiment, a remote user computer (310) is coupled to the remote line cards (305-307). The remote user computer (310) can then communicate over its communication link (321) with the network to which the system is connected.

In one embodiment, a local user computer (315) is coupled to one or more of line cards 1-N (301-303). The local user computer (315) enables a computer operator to interface with the system for maintenance and operation of the system. Both a local user computer (315) and a remote user computer (310) can access their respective local databases to which they are coupled. The local and remote user computers can then initiate the background synchronization method of the present invention.

The system of the present invention is not limited to a communication system as illustrated in FIG. 3. Any system that updates at least one local database from a master database is encompassed by the present invention.

FIG. 4 illustrates a block diagram of one embodiment of a management card of the present invention. In this embodiment, the management card has a controller (401) that controls the operation of the management card as well as the operation of the communication system. The controller (401) may be a microprocessor, a microcontroller, or some other form of control circuitry.

Memory (403) is coupled to the controller (401) to store data for use by the controller (401). The memory (403) might be any of the types described above as the database memory. In this embodiment, the memory (401) stores the master database of the present invention.

Input/Output (I/O) connections (405) enable the controller (401) to communicate with the other cards of the system. The I/O connections (405) might include circuit card contacts such as connectors, circuit card fingers, or other types of connections.

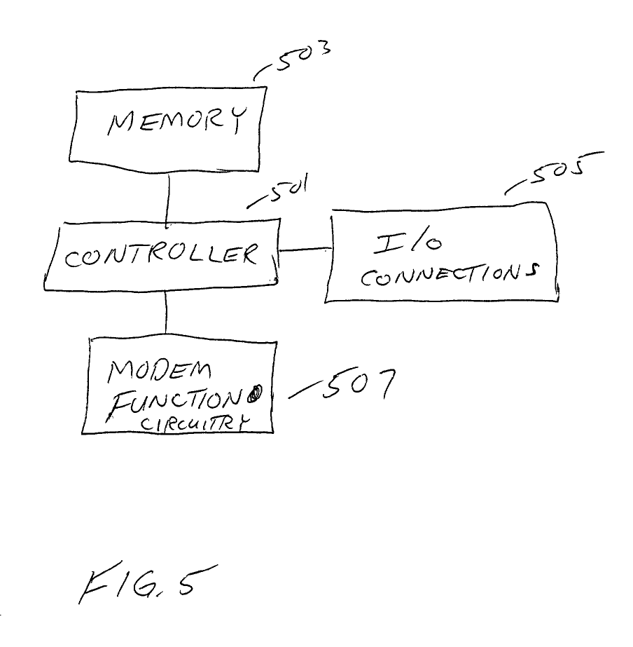

FIG. 5 illustrates a block diagram of one embodiment of a line card of the present invention. In this embodiment, the line card has a controller (501) that controls the operation of the line card communication circuitry. The controller (501) may be a microprocessor, a microcontroller, or some other form of control circuitry.

Memory (503) is coupled to the controller (501) to store data for use by the controller (501). The memory (503) might be any of the types described above as the database memory. In this embodiment, the memory (501) stores the local database(s) of the present invention.

Input/Output (I/O) connections (505) enable the line card to communicate with the management card as well as other cards of the system. In one embodiment, the I/O connections (505) include circuit card contacts such as connectors, circuit card fingers, or other types of connections.

Modem function circuitry (507) provides the line card with the ability to communicate over communication links with other modems. Modem operation is well known in the art and is not discussed further. The modem function circuitry (507) is coupled to the controller (501) and enables the local communication system to communicate over the communication links with remote modems that are coupled to computers.

In summary, the database access blocking of the present invention denies access to a local database prior to successful synchronization of the data with a master database. The method operates in the background to free up processing time so that a controlling device need only check status flags periodically to determine if the local database has been synchronized.

Numerous modifications and variations of the present invention are possible in light of the above teachings. It is therefore to be understood that within the scope of the appended claims, the invention may be practiced otherwise than as specifically described herein.

What is claimed is:

1. A method for local database access blocking during synchronization with a master database, the local database is capable of storing objects to be synchronized, the method comprising:
setting a status flag for each object to be synchronized indicating that each object to be synchronized is not synchronized;
requesting synchronization of the objects to be synchronized with the master database;
reading the status flag for at least one of the objects to be synchronized; and
enabling access to the local database when the status flag for the at least one object to be synchronized indicates synchronization.

2. The method of claim 1 wherein the objects to be synchronized comprise communication statistics.

3. The method of claim 2 wherein the communication statistics include bit error rate of a communication link.

4. The method of claim 1 wherein the status flag comprises a first indication when the objects to be synchronized are synchronized with the master database and a second indication when the objects to be synchronized are not synchronized with the master database.

5. The method of claim 1 and further including a plurality of local databases wherein a first local database of the plurality of local databases comprises a different group of objects to be synchronized with the master database than a second local database of the plurality of local databases.

6. The method of claim 1 wherein reading the status flag for at least one of the objects to be synchronized comprises reading the status flag for each of the objects to be synchronized.

7. The method of claim 6 and further including enabling access to the local database when each of the status flags for the objects to be synchronized indicates synchronization.

8. The method of claim 1 wherein reading the status flag for at least one of the objects to be synchronized comprises reading the status flag of a last synchronized object.

9. A method for local database access blocking during synchronization with a master database, the local database comprising a plurality of objects that further includes a subset of objects to be synchronized, the method comprising:
setting a status flag for each object of the objects to be synchronized indicating that each object to be synchronized is not synchronized;
requesting synchronization of the objects to be synchronized with the master database;
reading the status flag for at least one of the objects to be synchronized; and
blocking access to the local database until the status flag for the at least one object to be synchronized indicates synchronization.

10. The method of claim 9 and further including creating the local database by storing in memory the subset of objects to be synchronized.

11. The method of claim 10 wherein the memory comprises one of semiconductor memory, magnetic memory, or optical memory.

12. In a distributed database system comprising a master database and a plurality of local databases, a method for local database access blocking during synchronization with a master database, each local database comprising a plurality of objects to be synchronized, the method comprising:
setting a status flag for each object of the objects to be synchronized indicating that each object to be synchronized is not synchronized;
requesting synchronization of the objects to be synchronized with the master database;
reading the status flag for at least one of the objects to be synchronized; and
blocking access to the local database until the status flag for the at least one object to be synchronized indicates synchronization.

13. The method of claim 12 wherein the status flag comprises a “pending” status and a “ready” status.

14. A method for local database access blocking during synchronization with a master database, the method comprising:
generating the local database by storing a plurality of objects from the master database to the local database;
designating that each object is not synchronized;
requesting synchronization of the objects with the master database;
determining when each of the objects has been synchronized; and
enabling access to the local database when each object has been synchronized.

15. The method of claim 14 wherein designating that each object is not synchronized includes setting a data bit to a first predetermined state.

16. The method of claim 15 wherein determining when each of the objects has been synchronized includes checking that the data bit is in a second predetermined state.

17. A distributed database system that blocks database access during synchronization, the system comprising:
a master database comprising a plurality of objects, each object having a status indication; and
a plurality of local databases, coupled to the master database, that store at least a subset of the plurality of objects, each of the plurality of local databases capable of blocking read access to the subset of the plurality of objects until at least one of the status indication indicates a synchronized state.

18. The system of claim 17 wherein the status indication comprises a data bit having a “pending” condition to indicate a non-synchronized state and a “ready” condition to indicate a synchronized state.

19. A communication system comprising:
a controller card having a master database, the master database comprising a plurality of objects, each object having a status indication; and
a plurality of modem cards, each modem card having a local database coupled to the master database, each local database capable of storing at least a subset of the plurality of objects, each of the plurality of modem cards capable of blocking read access to the subset of the plurality of objects until the status indications indicate a synchronized state.

20. The communication system of claim 19 wherein the synchronized state is indicated when each of the status indications in a local database indicates the synchronized state.

21. The communication system of claim 19 wherein the synchronized state is indicated when an object that is downloaded last from the master database is stored in an appropriate local database with its status indication indicating a synchronized state.
